(19) United States
(12) Patent Application Publication
(10) Pub. No.: US 2007/0153799 A1
(43) Pub. Date: Jul. 5, 2007

(54) Providing services over hybrid networks

(75) Inventors: Piero Sorrini, Ottawa (CA); Gatot Susilo, Kanata (CA); John Fischer, Stittsville (CA)

Correspondence Address: Arnold B. Silverman;Eckert Seamans Cherin & Mellott, LLC, 44th Floor, 600 Grant Street, Pittsburgh, PA, 15022, US

(73) Assignee: Alcatel, Paris (FR)

(21) Appl. No.: 11/324,534

(22) Filed: Jan. 3, 2006

(51) Int. Cl. H04L 12/56

(52) U.S. Cl. 370/395.1; 370/401

(57) ABSTRACT

In hybrid networks, there are different schemes to identify traffic. ATM networks identify traffic on two levels. The present invention provides a method and apparatus of identifying traffic in a hybrid network on two or more levels. The method comprises mapping, at each level, the identifiers for identifying traffic in one network to identifiers for identifying traffic in an other network. The apparatus comprises an input module for receiving identifiers for identifying traffic on two or more levels for one of the networks; a mapping module for creating a map which for each level of identifier, maps the identifiers received to identifiers for another network.

### FIELD OF THE INVENTION

The present invention relates to communicating over networks having different identification schemes.

### BACKGROUND

DSL (Digital Subscriber Line) services are conventionally provided over ATM (Asynchronous Transfer Mode) networks and may be managed on a per-service and a per-customer basis. For example, each service is assigned a VPI (Virtual Path Identifier) and for each VPI, there is a list of customers, each customer being assigned a VCI (Virtual Circuit Identifier). Examples of services include, but are not limited to, Internet services, video, audio, television, and VoIP (Voice over Internet Protocol).

An example of an ATM DSL services solution is shown in FIG. 1. Traffic between one or more service provider and a plurality of customers (C) enters an ATM network 110 through a BRAS (Broadband Remote Access Server) 120 on the service provider side and through a router/switch 130 on the customer side. ATM DSLAMs (DSL Access Multiplexers) 140 and 150 are located between the interworking network element 130 and the customers (C). A DSLAM receives signals from multiple customer Digital Subscriber Line (DSL) connections and puts the signals on a high-speed backbone line using multiplexing techniques. Depending on the product, DSLAM multiplexers connect DSL lines with some combination of asynchronous transfer mode (ATM), frame relay, or Internet Protocol networks. Each ATM DSLAM may support several services and supports a plurality of customers. PVP (Permanent Virtual Path) or S-PVP (Switched-Permanent Virtual Path) is provisioned for each type of service provided to each ATM DSLAM 140 or 150. Each PVP or S-PVP is identified by a virtual path identifier (VPI). Typically, the path to each ATM DSLAM is identified with its own VPI, but in some cases, more than one ATM DSLAM can have the same VPI. A virtual circuit, identified by a virtual circuit identifier (VCI) is provisioned for each customer (C) of the ATM DSLAMs 140 and 150. The ATM DSLAMs direct traffic to the appropriate customer (C) based on the VCI.

In the example of FIG. 1, there are two VPIs, VPI₁ and VPI₂, which identify the paths to the ATM DSLAMs 140 and 150 respectively. The ATM DSLAM 140 supports three customers, identified by VCI₁, VCI₂ and VCI₃. The ATM DSLAM 150 supports two customers identified by VCI₁ and VCI₂. Traffic is thus identified with a VPI/VCI according to which ATM DSLAM and which customer it is directed.

Traffic in an Ethernet is identified by a VLAN (Virtual Local Area Network) identifier or tag in the header of an Ethernet frame. A standard Ethernet frame can include stacked VLAN tags.

Hybrid networks comprised of two or more networks that identify traffic using different protocols also exist. For example, a hybrid network may be made up of an ATM network and an Ethernet. Another example of a hybrid network is a network comprised of an MPLS (Multiple Protocol Labelling System) network and an Ethernet. Any combination of ATM, Ethernet, IP (Internet Protocol), MPLS, etc may make up a hybrid network.

### SUMMARY OF THE INVENTION

In one aspect of the present invention, there is provided a method of identifying traffic in a hybrid network, the hybrid network comprising two or more networks having different schemes for identifying traffic on two or more levels, the method comprising: mapping, at each level, the identifiers for identifying traffic in one network to identifiers for identifying traffic in an other network.

In another aspect of the present invention, there is provided a computer readable medium having computer readable instructions stored thereon that when executed by a computer implement any of the methods described herein.

In another aspect of the present invention, there is provided an apparatus for mapping traffic identifiers in a hybrid network, the hybrid network comprising two or more networks having different schemes for identifying traffic on two or more levels, the apparatus comprising: an input module for receiving identifiers for identifying traffic on two or more levels for one of the networks; a mapping module for creating a map which for each level of identifier, maps the identifiers received to identifiers for another network.

Embodiments of the present invention enable traffic in a hybrid network to be identified on two or more levels in a uniform manner, regardless of the identification scheme of the various networks that make up the hybrid network. For example, in a hybrid network comprised of an ATM network and an Ethernet, DSL traffic within the ATM network can be identified by VPI/VCI at the service provider end. The VPI/VCI DSL traffic directed to customers over the Ethernet will be mapped to a two level VLAN identifier. For example, the VLAN identifier could be comprised of an S-VLAN/C-VLAN identifier (where S is for service, and C is for customer).

Other aspects and features of the present invention will become apparent, to those ordinarily skilled in the art, upon review of the following description of the specific exemplary embodiments of the invention.

### BRIEF DESCRIPTION OF THE DRAWINGS

Exemplary embodiments of the invention will now be described in greater detail with reference to the accompanying drawings, in which:

FIG. 1 is a block diagram of a conventional ATM network for delivering DSL services;

FIG. 2 is a block diagram of a hybrid network in accordance with one embodiment of the present invention;

FIG. 3 is a block diagram of a hybrid network in accordance with one embodiment of the present invention;

FIG. 4 is a flowchart of a method for identifying traffic in accordance with one embodiment of the present invention;

FIG. 5 is a flowchart of a method for identifying traffic in accordance with one embodiment of the present invention;

FIG. 6 is a flowchart of a method for identifying traffic in accordance with one embodiment of the present invention;

FIG. 7 is a block diagram of an apparatus for identifying traffic in accordance with one embodiment of the present invention; and

FIG. 8 is a diagram of a map in accordance with one embodiment of the present invention.

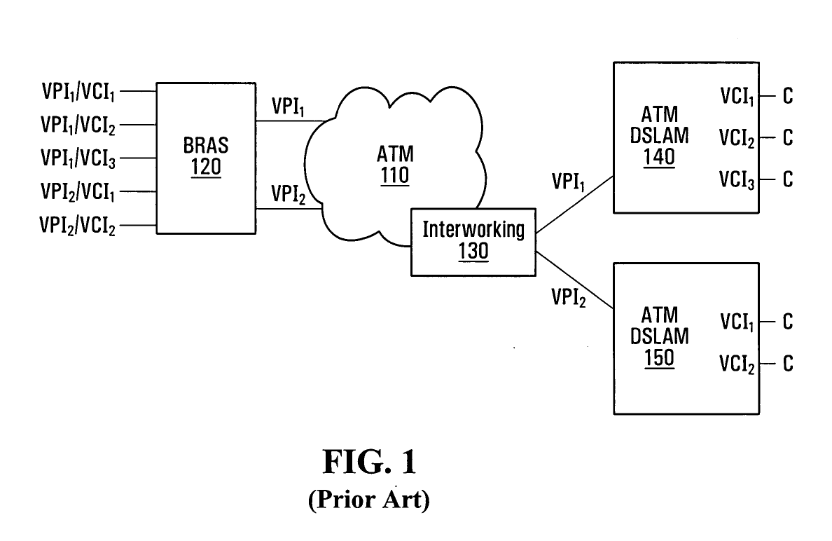

### DESCRIPTION OF EMBODIMENTS

Throughout this description, the expressions “map”, “mapped” and “mapping” are used to refer to any association, allocation or assignment of one identifier to another identifier.

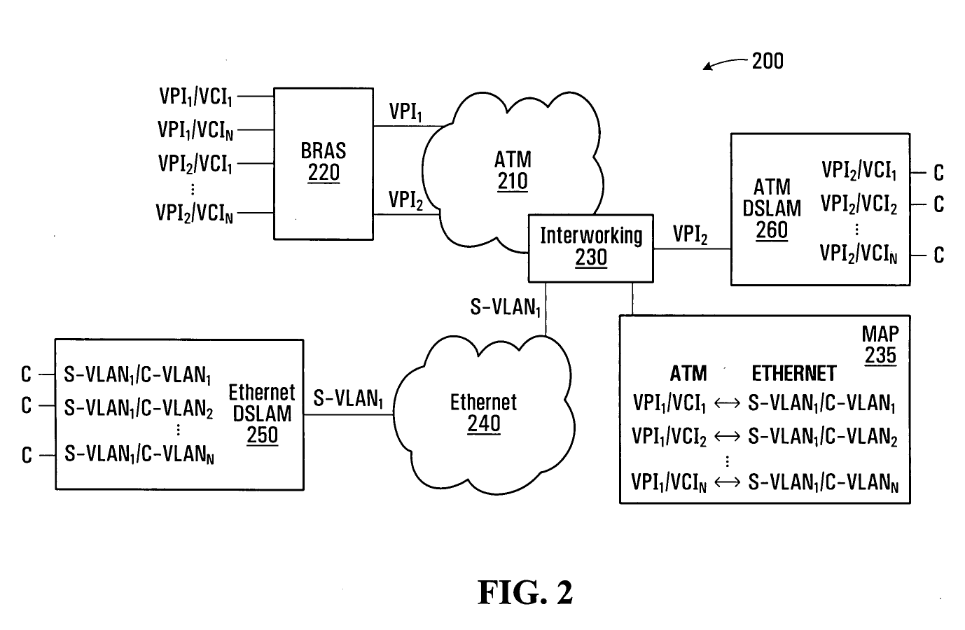

An ATM DSLAM to Ethernet DSLAM migration scenario according to one embodiment of the present invention is shown in FIG. 2. A hybrid network 200 comprises an ATM network 210 and an Ethernet 240. An ATM DSLAM 260 connects customers to the ATM network 210 through an interworking network element 230, and an Ethernet DSLAM 250 connects customers to the Ethernet 240, which is in turn connected to the ATM network 210 through the interworking network element 230. The ATM DSLAM 260 is identified by VPI₁, and the Ethernet DSLAM is identified by SVLAN₁. DSL service providers connect to the ATM network 210 through a BRAS 220. Thus, the Ethernet DSLAM 250 has connectivity to the BRAS 220 through the ATM network 210 and the Ethernet network 240 via the interworking network element 230. The interworking network element 230 provides an interworking function between the ATM network 210 and the Ethernet network 240 for data packet traffic flowing between the BRAS 220 and the Ethernet DSLAM 250. An interworking function provides the means for two different technologies to interoperate.

In some embodiments the Ethernet 240 is a metro Ethernet. In some embodiments, the Ethernet DSLAM 250 is an IP DSLAM. Examples of the interworking network element 230 include a node, switch, router, switch/router, as well as other network elements.

For ease of management and deployment it is desirable to keep the same paradigm as all ATM DSL solutions with respect to connection management and customer provisioning, such where the service type is identified with a VPI and the customer is identified with a VCI. To that end, some embodiments of the present invention use stacked VLAN tags with one VLAN ID for each service type (S-VLAN) and another for each customer (C-VLAN). In embodiments where Ethernet frames allocate 12 bits to VLAN IDs, the maximum number of C-VLANs per S-VLAN will be approximately 4,000. The interworking network element 230 has access to a map 235 which maps data packets received from one VPI/VCI to the appropriate S-VLAN/C-VLAN, and vice versa. For example, data packets of VPI₂/VCI₁ would be mapped to S-VLAN₁/C-VLAN₁. In some embodiments the map 235 is maintained on the interworking network element 230. The map 235 is updated with the addition and removal of services and DSLAMs.

For PVP in the embodiment of FIG. 2, each node is individually configured to create the necessary cross-connects for the path. For the path to the Ethernet DSLAM 250, a cross-connect on the interworking network element 230 is made between an endpoint (EP1) connecting to VPI2 on the ATM network 210 side to an endpoint (EP2) connecting to S-VLAN1 at the Ethernet network 240 side. The interworking network element 230 is configured by provisioning the path, for example, as follows:

EP1=1-3-1-1; VPI2

EP2=1-5-1-1; V1

#cust=100

#starting VCI=32

In this example, 1-3-1-1 is a port number for endpoint EP1, VPI2 is a VPI number for endpoint EP1, 1-5-1-1 is a port number for endpoint EP2, and V1 is a VLAN ID for EP2. Then a mapping table is automatically generated for mapping 100 C-VLANs for S-VLAN1 to 100 VCIs, starting at VCI32 for VPI2.

In another approach, destination configuration endpoints are added to the network. For example they can be added to the network 200 described with reference to FIG. 2 at the interworking network element 230 on the side linking to the Ethernet 240 and on the side linking to the ATM DSLAM 260. These destination configuration endpoints are used for provisioning parameters that can not be provisioned using signalling, such as in the case where S-PVPs are used. Destination configuration endpoints are configured locally. An example of how a destination configuration endpoint (EP3) is provisioned for a S-PVP is:

EP3=1-5-1-1; V5

# customer=X

# starting VCI=Y

In this case a mapping table is generated at the interworking network element mapping X VCIs starting at VCI Y to X C-VLAN IDs for EP3.

An advantage of using destination configuration endpoints is that the provisioning of an S-PVP can be changed without affecting services carried on it. For example, another set of VCIs for new customers can be added to the S-PVP by provisioning at the destination configuration endpoint. Furthermore, it is unnecessary to change the signalling protocol.

In other cases, extra information is embedded in the signalling. IEs (Information Elements) can be modified or new IEs can be added. In some cases, new IEs are used in conjunction with, for example, the PNNI modify request message. This technique does not require connect/re-connect actions which would be service affecting in order to implement provisioning changes to S-PVPs. Adding new IEs would require modifications to the standards. For instance, Generic Identifier Transport (GIT) information element may be used to describe the correlation of mapping between VCI and C-VLAN in the interworking node as the destination node.

Embodiments of the present invention are applicable to interworking other types of dissimilar networks, such as MPLS and Ethernet for the purposes of providing DSL services. In these cases, the general concept is the same. Hierarchical VLAN IDs for identifying traffic of the Ethernet on a per-service and per-customer basis are provided and then mapped at an interworking network element between the networks to a corresponding hierarchical arrangement of connections or pseudo-wire connections.

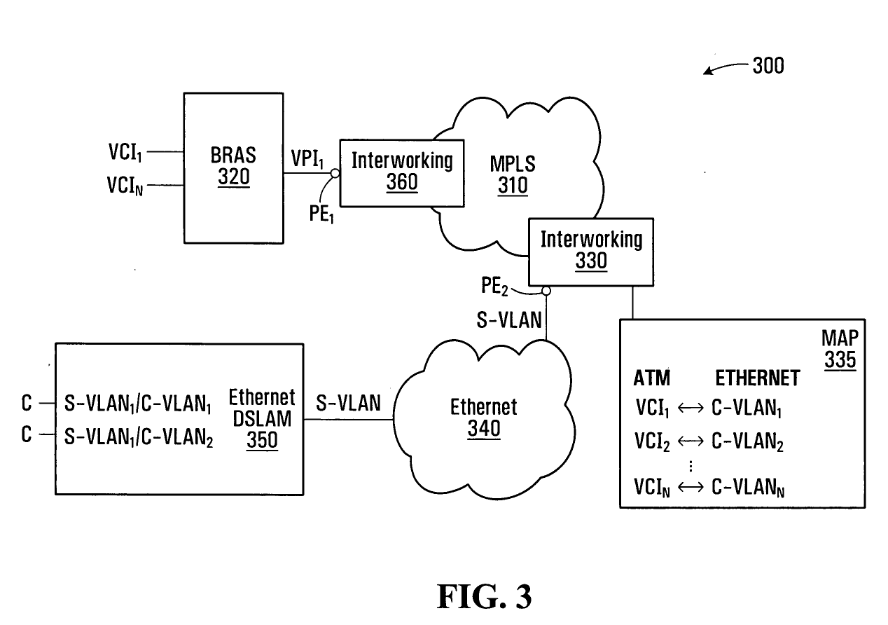

FIG. 3 is a block diagram of one embodiment of the present invention in which an MPLS network and an Ethernet are interworked. A hybrid network 300 comprises and an MPLS network 310 and an Ethernet 340. An Ethernet DSLAM 350 connects customers to the Ethernet 340, which is in turn connected to the MPLS network 310 through an interworking network element 330. The Ethernet DSLAM is identified by SVLAN₁. DSL service providers connect to the MPLS network 310 through a BRAS 320. The BRAS 320 is connected to the MPLS network 310 through an interworking network element 360. Thus, the Ethernet DSLAM 350 has connectivity to the BRAS 320 through the MPLS network 310 via interworking network element 330, the Ethernet network 340 and the interworking network element 320. The interworking network element 330 provides an interworking function between the MPLS network 310 and the Ethernet network 340 for data packet traffic flowing between the BRAS 320 and the Ethernet DSLAM 350. The interworking network element 360 provides an interworking function between the BRAS 320 and the MPLS 310. In some embodiments, the BRAS 320 is an ATM BRAS. There are two PEs (Provider Edges): one between the BRAS and MPLS network (PE1) and another between the MPLS network and Metro-Ethernet network (PE2). In this case, a VPI on PE1 facing the ATM BRAS and an S-VLAN on PE2 facing the Metro-Ethernet network are connected as VP-level ATM pseudo-wires. In the MPLS network 310, there are two MPLS labels: the outer label corresponds to the tunnel LSP and the inner label corresponds to the VP-S-VLAN connection. In some cases, the inner label is called a Pseudo-wire (PW) label. The outer label is managed by MPLS signalling.

One embodiment of the invention provides mapping of VPI to PW label at PE1. The PW label is used across the MPLS network 310 and the VCI is carried across the MPLS network 310. Then at PE2, the PW label is mapped to a S-VLAN and the VCI is mapped to a C-VLAN to produce a map 335 from MPLS/ATM identifiers to Ethernet identifiers for the customers. In this case the sequence of mapping is: VPI/VCI=>PW label/VCI=>S-VLAN/C-VLAN.

Another embodiment is adapted to provide a mapping of VCI to C-VLAN at PE1, in addition to the mapping of VPI to PW label. Then at PES the PW label can be mapped to a S-VLAN. In this embodiment, the sequence of mapping is: VPI/VCI=>PW label/C-VLAN=>S-VLAN/C-VLAN.

In another embodiment of the present invention, an Ethernet VLAN BRAS is used and an MPLS network interconnects the BRAS and an Ethernet network. There are two PEs: one between the BRAS and MPLS network and another one between MPLS Network and Metro-Ethernet network. In this case, an S-VLAN facing the Ethernet VLAN BRAS and an S-VLAN facing the Ethernet network are connected as an ethernet pseudo-wire. In the MPLS network, there are three MPLS labels: 1) the outer label corresponding to a tunnel LSP, 2) the first inner label corresponding to the S-VLAN and 3) the second inner (innermost) label corresponding to the C-VLAN. The two PEs perform mapping of the inner label to S-VLAN and mapping of the innermost label to the C-VLAN in similar manner as VCI-C-VLAN mapping described with reference to FIGS. 2 and 3. Unlike the outer label and the first inner label, which are typically platform-wide labels allocated by PEs, the innermost label is unique within each first inner label. This allows scalability capabilities on PEs with respect to managing the innermost label. In this S-VLAN identifiers are used at the BRAS.

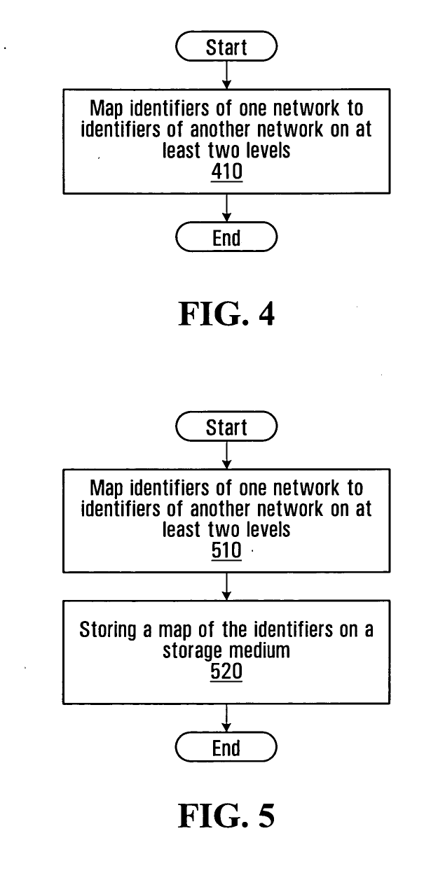

FIG. 4 is a flowchart of a method of identifying traffic in a hybrid network. The hybrid network comprises two or more networks having different schemes for identifying traffic on two or more levels. Step 410 of the method comprises mapping at each level, the identifiers for identifying traffic in one network to identifiers for identifying traffic in another network.

In some embodiments, one level of the identifiers of at least one of the networks identifies a service type of the traffic. In some cases, one level of the identifiers of at least one of the networks identifies a customer.

In some embodiments, one level of the identifiers of at least one of the networks is mapped to a VPI (Virtual Path Identifier) in another network. In some cases, the VPI represent a service type. Types of service include, but are not limited to internet service, video, television, audio, and VoIP.

In some embodiments, one level of the identifiers of at least one of the networks is mapped to a VCI (Virtual Circuit Identifier) in another network. In some cases, the VCI represents a customer.

FIG. 5 is a flowchart of a method of identifying traffic in a hybrid network in accordance with one embodiment of the present invention. The hybrid network comprises two or more networks having different schemes for identifying traffic on two or more levels. Step 510 is the same as step 410 described with reference to FIG. 4. Step 520 is storing a map of the traffic identifiers on a storage medium.

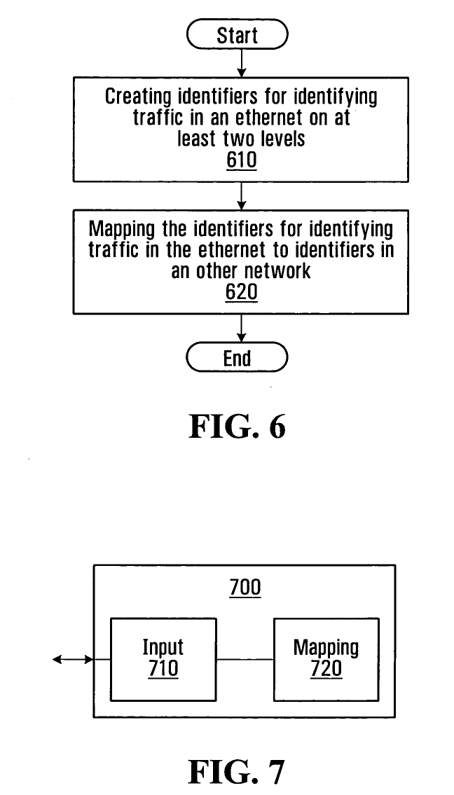

FIG. 6 is a flowchart of a method of identifying traffic in a hybrid network in accordance with one embodiment of the present invention. The hybrid network comprises two or more networks having different schemes for identifying traffic on two or more levels, one of those networks being an Ethernet. Step 610 creates identifiers for identifying traffic in the Ethernet network on two or more levels. Step 620 maps the identifiers for identifying traffic in the Ethernet to identifiers for identifying traffic in another network.

In some embodiments, in each network, one level of identifiers is a subset of another level of identifiers. In some embodiments, the Ethernet identifiers are VLAN IDs (Virtual Local Area Network Identifiers) stacked in Ethernet frames.

Methods in accordance with embodiments of the present invention can be implemented on any hybrid network. In exemplary embodiments, the networks making up the hybrid network are selected from the group consisting of: an ATM (Asynchronous Transfer Mode) network; an Ethernet; an IP (Internet Protocol) network; a VLAN (Virtual Local Area Network); and an MPLS (Multiple Protocol Labelling System) network.

In a preferred embodiment, the method is applied to DSL subscriber access. In such a case, the traffic is DSL traffic. However, embodiments of the present invention are not limited to DSL subscriber access. Other types of subscriber access include, but are not limited to digital cable, and wireless communications.

The methods of embodiments of the present invention can be implemented in hardware, software or combination thereof. Some embodiments comprise a computer readable medium having computer readable instructions stored thereon that when executed by a computer implement any of the methods described herein.

FIG. 7 is a block diagram of an apparatus 700 for mapping traffic identifiers in a hybrid network. The hybrid network comprises two or more networks having different schemes for identifying traffic on two or more levels. The apparatus 700 comprises an input module 710 and a mapping module 720. The input module 710 is for receiving identifiers for identifying traffic on two or more levels for one of the networks. The mapping module 720 is for creating a map which for each level of identifier. The mapping module 720 maps the identifiers received to identifiers for another network. The apparatus 700 can be part of a network element in a hybrid network, such as a node, switch, router, switch/router, etc.

In some embodiments, the apparatus 700, further comprises an identifier creation module for creating identifiers on two or more levels for traffic in the other network.

In some embodiments, the apparatus further comprises an output module for outputting the map to a user interface. In some embodiments, the apparatus 700, further comprises the user interface.

In some embodiments, the apparatus 700, further comprises a switching module for directing traffic according to the identifiers of either of the networks.

In some embodiments, the mapping module 720 maps VPIs and VCIs from an ATM to stacked VLAN (Virtual Local Area Network) identifiers for an Ethernet.

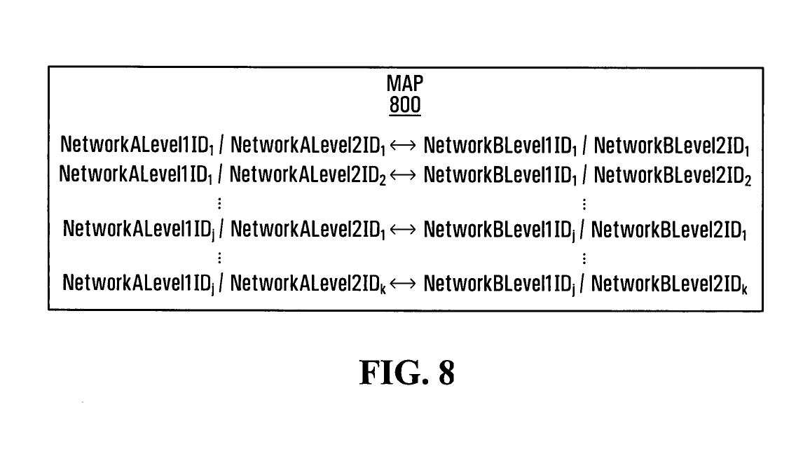

FIG. 8 is a block diagram of a map 800 in accordance with one embodiment of the present invention. It comprises identifiers from a first network, Network A, each identifier comprising two levels of identifiers, Level 1 and Level 2. Each identifier from Network A is mapped to a two level identifier in Network B. For example, the identifier NetworkALevel1ID1/NetworkALevel2ID1 is mapped to NetworkBLevel1ID1/NetworkBLevel2ID1. The number of IDs for Level 1 of each network is any number from 1 to j, where j is a positive integer. The number of Level 2 IDs of each network is any number from 1 to k, where k is a positive integer. In some networks, the identifiers are sent in the header of a frame and are allotted a certain number of bits. If the number of bits allotted is 12, as with VLAN IDs in an Ethernet frame, then j or k would be approximately 4000.

The map 800 is stored on a machine readable storage medium and accessible by a network element that must direct traffic from one network to another. Examples of such an interworking network element are described with reference to FIGS. 2 and 3. In some embodiments, the map 800 is located on the interworking network element. In other embodiments, the map is generated by the interworking network element.

What has been described is merely illustrative of the application of the principles of the invention. Other arrangements and methods can be implemented by those skilled in the art without departing from the spirit and scope of the present invention.

1. A method of identifying traffic in a hybrid network, the hybrid network comprising two or more networks having different schemes for identifying traffic on two or more levels, the method comprising:
mapping, at each level, the identifiers for identifying traffic in one network to identifiers for identifying traffic in an other network.

2. The method of claim 1, wherein at least one of the networks is an Ethernet network and further comprising creating identifiers for identifying traffic in the Ethernet network on two or more levels.

3. The method of claim 1, further comprising storing a map of the traffic identifiers on a storage medium.

4. The method of claim 2, wherein, in each network, one level of identifiers is a subset of another level of identifiers.

5. The method of claim 1, wherein a level of the identifiers of at least one of the networks identifies a service type of the traffic.

6. The method of claim 1, wherein a level of the identifiers of at least one of the networks is mapped to a VPI (Virtual Path Identifier) in an other network.

7. The method of claim 1, wherein a level of the identifiers of at least one of the networks identifies a customer.

8. The method of claim 1, wherein a level of the identifiers of at least one of the networks is mapped to a VCI (Virtual Circuit Identifier) in another network.

9. The method of claim 2, wherein the Ethernet identifiers are VLAN IDs (Virtual Local Area Network Identifiers) stacked in Ethernet frames.

10. The method of claim 1, wherein the networks are selected from the group consisting of: an ATM (Asynchronous Transfer Mode) network; an Ethernet; an IP (Internet Protocol) network; a VLAN (Virtual Local Area Network); and an MPLS (Multiple Protocol Labelling System) network.

11. The method of claim 1, wherein the traffic is DSL (Digital Subscriber Line) traffic.

12. A computer readable medium having computer readable instructions stored thereon that when executed by a computer implement the method of claim 1.

13. An apparatus for mapping traffic identifiers in a hybrid network, the hybrid network comprising two or more networks having different schemes for identifying traffic on two or more levels, the apparatus comprising:
an input module for receiving identifiers for identifying traffic on two or more levels for one of the networks;
a mapping module for creating a map which for each level of identifier, maps the identifiers received to identifiers for another network.

14. The apparatus of claim 13, further comprising an identifier creation module for creating identifiers on two or more levels for traffic in the other network.

15. The apparatus of claim 13, further comprising an output module for outputting the map to a user interface.

16. The apparatus of claim 14, further comprising the user interface.

17. The apparatus of claim 13, further comprising a switching module for directing traffic according to the identifiers of either of the networks.

18. The apparatus of claim 13, wherein the networks are selected from the group consisting of: an ATM (Asynchronous Transfer Mode) network; an Ethernet; an IP (Internet Protocol) network; a VLAN (Virtual Local Area Network); and an MPLS (Multiple Protocol Labelling System) network.

19. The apparatus of claim 13, wherein identifiers received comprise VPIs (Virtual Path Identifiers) and VCIs (Virtual Circuit Identifiers).

20. The apparatus of claim 19, wherein the mapping module maps the VPIs and VCIs to VLAN (Virtual Local Area Network) identifiers.
